(19) United States
(12) Patent Application Publication
(10) Pub. No.: US 2006/0280167 A1
(43) Pub. Date: Dec. 14, 2006

(54) Method of setting up calls between a calling terminal and a called terminal

(75) Inventors: Marc Pelous, Paris (FR); Jean-Christophe Le Gall, Treillieres (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/441,079

(22) Filed: May 26, 2006

(30) Foreign Application Priority Data
May 31, 2005 (FR) 0551418

(51) Int. Cl. H04L 12/66; H04L 12/56

(52) U.S. Cl. 370/352; 370/395.2; 370/401

(57) ABSTRACT

The invention relates to methods of setting up a video call between a calling terminal (UEA) and a called terminal (UEB) via a telecommunications network. The method comprises a request step of requesting the setting up of a call between the calling terminal and the called terminal, an alert step of indicating that the called terminal has been alerted, a connection step of indicating that a user of the called terminal has taken the call, and a negotiation step of negotiating the setting up of audio and video logical channels between the calling terminal and the called terminal; the beginning of the negotiation step is after the beginning of the alert step and before the beginning of the connection step.

The invention relates to methods of setting up calls between a calling terminal and a called terminal. Following a successful call set-up stage, these methods require end-to-end negotiation processed by the terminals rather than the intermediate nodes. The invention relates more particularly to video calls. To set up a video call, a connection and audio and video logical channels must be set up between the calling terminal and the called terminal.

Audio and video logical channel set-up negotiation conventionally begins once the connection between the terminals has been set up. This standard procedure has two drawbacks, however. Firstly, the set-up time for a video call is relatively long. Secondly, the time taken to set up the logical channels is billed to users, since it occurs after the connection between the terminals of the users has been set up.

It would therefore be beneficial to be able to set up the logical channels, or at least be able to begin to set them up, before the connection between the terminals of the users is set up. No new messages over and above the existing standard procedure are needed. However, the behavior of the terminals must be adapted to the extent that, instead of waiting for the connection to be set up, the terminals must begin to negotiate logical channel set-up before the connection between them is set up.

According to the prior art described in US Patent Application US2004/0174817 in relation to the type III method, setting up of the logical channels between the terminals is negotiated before setting up the connection between the terminals. The negotiation is effected during the call set-up request step, before the called terminal is alerted, and necessitates the use of user-to-user information. However, the user-to-user information is optional in the sense that it is not present in all types of network and in particular it is absent in circuit-switched networks (as opposed to packet-switched networks). In circuit-switched networks, operators take steps to prevent circulation of this information, for financial reasons in particular. Also, using this information proves relatively complex in the sense that it requires the terminal to integrate an additional element into the call set-up request step. What is more, using the user-to-user information requires a set of predefined profiles to be standardized, and this induces a limitation at the level of the number of possible combinations of the parameters defined in the profiles, which may become a problem on increasing the number of available codecs (coders-decoders).

To remedy the above-mentioned drawbacks, the invention proposes to move away from the requirement to have this user-to-user information in order to begin the logical channel set-up negotiation. To this end, the invention proposes to begin logical channel set-up negotiation after the called terminal has been alerted. Logical channel set-up negotiation can therefore begin before setting up the connection between the terminals, in a simpler and more effective way, and without it being necessary to use user-to-user information.

The invention relates to a method of setting up video calls between a calling terminal and a called terminal, to a calling terminal specifically adapted to implement the video call set-up method of the invention, and to a called terminal specifically adapted to implement the video call set-up method of the invention.

The invention provides a method of setting up a video call between a calling terminal and a called terminal via a telecommunications network, the method comprising: a request step of requesting the setting up of a call between the calling terminal and the called terminal, an alert step of indicating that the called terminal has been alerted, a connection step of indicating that a user of the called terminal has taken the call, and a negotiation step of negotiating the setting up of audio and video logical channels between the calling terminal and the called terminal; the method is characterized in that the beginning of the negotiation step is after the beginning of the alert step and before the beginning of the connection step. The beginning of the negotiation step is preferably after the end of the alert step.

The invention also provides a calling terminal suitable for sending a call set-up request message, for receiving an alert message indicating that a called terminal has been alerted, for receiving a connection message indicating that a user of a called terminal has taken the call, and for negotiating with a called terminal both the setting up of a signaling channel and also the setting up a multiplex for the signaling channel and the audio and video logical channels; the calling terminal is characterized in that it includes means for starting negotiation after receiving the alert message but before receiving the connection message.

The invention further provides a called terminal suitable for receiving a call set-up request message, for sending an alert message indicating that said called terminal has been alerted, for sending a connection message indicating that a user of said called terminal has taken the call, and for negotiating with the calling terminal both the setting up of a signaling channel and also the setting up of a multiplex for the signaling channel and the audio and video logical channels; the called terminal is characterized in that it includes means for starting negotiation after sending the alert message but before sending the connection message.

The invention can be better understood and other features and advantages thereof become apparent in the light of the following description and the appended drawings, which are provided by way of example and in which:

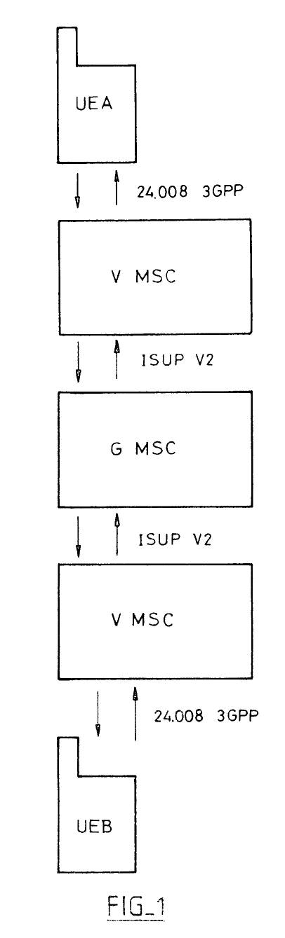

FIG. 1 is a diagram showing one example of a system comprising two terminals and a portion of the telecommunications network over which the terminals communicate with each other; and

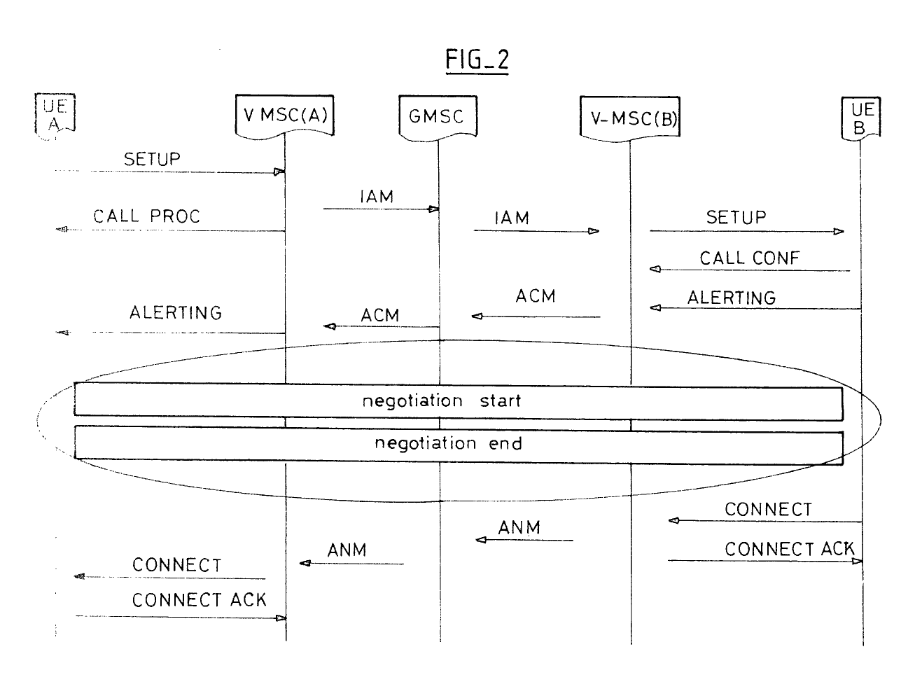

FIG. 2 is a diagram showing one example of a video call set-up method of the invention.

FIG. 1 is a diagram of one example of a system comprising two terminals and a portion of the telecommunications network over which the terminals communicate with each other. The telecommunications network includes a gateway mobile switching center (GMSC) referred to below as the gateway switch GMSC, visited mobile switching centers (VMSC) referred to below as local switches VMSC, and terminals including a calling terminal UEA and a called terminal UEB. One local switch VMSC is connected to the calling terminal UEA and another local switch VMSC is connected to the called terminal UEB. Bidirectional communication between a terminal and a local switch VMSC conforms to the 3GPP 24.008 standard. Bidirectional communication between a gateway switch GMSC and a local switch VMSC conforms to the ISUP V2 standard.

The telecommunications network is preferably a circuit-switched network in which user-to-user information is eliminated by the operators and which uses the ITU H 324 protocol for video communication between users, for example, rather than a packet-switched network in which user-to-user information is present and usable more easily and in which the ITU H 323 protocol is used for video communication between users, for example. The telecommunications network is advantageously at least of the third generation, i.e. of the third generation or a subsequent generation.

Preferably, in the method of the invention for setting up a video call between a calling terminal and a called terminal, the call set-up request step extends between the calling terminal sending a call set-up request message and the called terminal receiving a call set-up request message, the alerting step extends between the called terminal sending an alert message indicating that the called terminal has been alerted and the calling terminal receiving an alert message indicating that the called terminal has been alerted, and the connection step extends between the called terminal sending a connection message indicating that a user of the called terminal has taken the call and the calling terminal receiving a connection message indicating that the user of the called terminal has taken the call.

In the method of the invention for setting up video calls between a calling terminal and a called terminal, the negotiation step preferably includes, firstly, setting up a signaling channel and, secondly, setting up a multiplex for the signaling channel and the audio and video logical channels. This negotiation step generally takes a few seconds, typically having a duration of the order of 5 to 10 seconds. Consequently, the time saved on each call between a calling terminal and a called terminal by using the method of the invention is at most the duration of the negotiation step, or only a portion of that duration if the user of the called terminal takes the call quickly, i.e. before the end of the negotiation step.

FIG. 2 is a diagram of one example of a video call set-up method of the invention. Bidirectional communication between a terminal and a local switch VMSC conforms to the 3GPP 24.008 standard. Bidirectional communication between a gateway switch GMSC and a local switch VMSC conforms to the ISUP V2 standard. Video communication between the terminals preferably conforms to the ITU H 324 protocol, hereby incorporated by reference, with reference to which FIG. 2 is described, and which should be consulted for the precise meaning and the precise names of messages. The method of setting up video calls between a calling terminal and a called terminal then conforms to the ITU H 324 protocol. The call set-up request step is denoted SETUP. The alerting step is denoted ALERTING. The connecting step is denoted CONNECT. The negotiation step conforms to a section of the ITU H 245 protocol for setting up a signaling channel and to the ITU H 223 protocol for setting up a multiplex for the signaling channel and the audio and video logical channels.

For the purposes of describing the various exchanges of messages, the local switch connected to the calling terminal UEA is denoted the local switch VMSC(A) and the local switch connected to the called terminal UEB is denoted the local switch VMSC(B). It is assumed that the communications medium between the terminals is open in both directions to enable bidirectional transmission of messages, i.e. transmission from the calling terminal to the called terminal and transmission from the called terminal to the calling terminal.

In order to take the initiative to request call set-up, the calling terminal UEA sends the local switch VMSC(A) a SETUP message. The local switch VMSC(A) sends the calling terminal UEA a CALL PROC message acknowledging reception of the request from the calling terminal and sends the gateway switch GMSC an IAM message forwarding the request from the calling terminal. The gateway switch GMSC sends the local switch VMSC(B) an IAM message forwarding the request from the calling terminal. The local switch VMSC(B) sends the called terminal UEB a SETUP message forwarding the request from the calling terminal.

The called terminal UEB sends the local switch VMSC(B) a CALL CONF message acknowledging to the local switch VMSC(B) reception of the request from the calling terminal and sends an ALERTING message to the calling terminal UEA to inform it that the called terminal UEB has been alerted by the request from the calling terminal. The local switch VMSC(B) sends the gateway switch GMSC a message ACM forwarding the alert from the called terminal. The gateway switch GMSC sends the local switch VMSC(A) an ACM message forwarding the alert from the called terminal. The local switch VMSC(A) sends the calling terminal UEA an ALERTING message forwarding the alert from the called terminal.

The step of negotiating logical channels between the terminals, which is normally effected in accordance with the ITU H 245 and ITU H 223 protocols, hereby incorporated by reference, then begins, as denoted by the line “negotiation start”. The end of this negotiation step is denoted by the line “negotiation end”.

The called terminal UEB sends the local switch VMSC(B) a CONNECT message reporting to the local switch VMSC(B) that the user of the called terminal UEB has taken the call. Reporting that the user of the terminal UEB has taken the call is referred to below as reporting the reaction of the called user. The local switch VMSC(B) sends the called terminal UEB a CONNECT ACK message acknowledging reception of the report of the reaction of the called user and sends the gateway switch GMSC an ANM message forwarding the report of the reaction of the called user. The gateway switch GMSC sends the local switch VMSC(A) an ANM message forwarding the report of the reaction of the called user. The local switch VMSC(A) sends the calling terminal UEA a CONNECT message forwarding the report of the reaction of the called user. The calling terminal UEA sends the local switch VMSC(A) a CONNECT ACK message acknowledging reception of the report of the reaction of the called user.

The beginning of the step of negotiating the setting up of logical channels between the terminals, denoted “negotiation start”, occurs between the called terminal UEB sending the ALERTING message and the called terminal UEB sending the CONNECT message. The beginning of this negotiation step may be before or preferably after reception of the ALERTING message by the calling terminal UEA. The end of this negotiation step, denoted “negotiation end”, may be before or after the called terminal UEB sends the CONNECT message, depending on how fast the called user reacts, i.e. depending on the time at which the user of the called terminal UEB takes the call.

In the calling terminal UEA, the logical channel set-up negotiation step begins just after receiving the ALERTING message. In the called terminal UEB, the logical channel set-up negotiation step begins either just after sending the ALERTING message or when the called terminal UEB detects that the calling terminal has begun the step of negotiating logical channel set-up and, for example, attempted to set up multiplexing. If the called user takes the call before the step of negotiating logical channel set-up has been completed, the logical channel set-up negotiation step continues normally, as if the called user had not taken the call.

This video call set-up method of the invention also has the advantage of being compatible with a fallback procedure from video to audio, conforming to the SCUDIF standard. This is beneficial if the called terminal supports only audio, being unable to support video.

The video call set-up method of the invention, which is characterized in particular by starting the logical channel set-up negotiation step ahead of time, is not applied if the calling terminal detects the use by the called terminal of a call-forwarding mechanism, for example forwarding to a video mailbox, if the called user is absent. The standard call-forwarding mechanism can be used by the called terminal, necessitating only an appropriate reaction on the part of the calling terminal.

In the method of the invention for video call set-up between a calling terminal and a called terminal, in the event of transfer from the called terminal to a call-forward terminal, a new step of negotiating the setting up of audio and video logical channels between the calling terminal and the call-forward terminal preferably begins only after the beginning of the step of connecting the calling terminal and the call-forward terminal.

If the called terminal activates the mechanism for forwarding calls to a call-forward terminal supporting video, for example to a video mailbox associated with the called terminal, the calling terminal detects the use of the call-forwarding mechanism. The calling terminal then shuts down the logical channels to the called terminal that it has opened or has begun to open.

The calling terminal has two ways to detect this use of the call-forward mechanism. The first way is to detect it by means of a timer. The second way is to detect it by virtue of receiving a message reporting the call forwarding to it. In either case, the calling terminal closes the logical channels to the called terminal that it has opened or has begun to open. Further negotiation of logical channels with the call-forward terminal will then begin only after a message is received reporting that the connection between the calling terminal and the call-forward terminal has been set up.

What is claimed is:

1. A method of setting up a video call between a calling terminal (UEA) and a called terminal (UEB) via a telecommunications network, the method comprising:
a request step of requesting the setting up of a call between the calling terminal and the called terminal;
an alert step of indicating that the called terminal has been alerted;
a connection step of indicating that a user of the called terminal has taken the call; and
a negotiation step of negotiating the setting up of audio and video logical channels between the calling terminal and the called terminal;
the method being characterized in that the beginning of the negotiation step is after the beginning of the alert step and before the beginning of the connection step.

2. A method according to claim 1, characterized in that the beginning of the negotiation step is after the end of the alert step.

3. A method according to claim 1, characterized in that the telecommunications network is a third or subsequent generation circuit-switched network.

4. A method according to claim 1, characterized in that:
the call set-up request step extends between the calling terminal sending a call set-up request message (SETUP) and the called terminal receiving a call set-up request message (SETUP);
the alert step extends between the called terminal sending an alert message (ALERTING) indicating that the called terminal has been alerted and the calling terminal receiving an alert message (ALERTING) indicating that the called terminal has been alerted; and
the connection step extends between the called terminal sending a connection message (CONNECT) indicating that a user of the called terminal has taken the call and the calling terminal receiving a connection message (CONNECT) indicating that the user of the called terminal has taken the call.

5. A method according to claim 1, characterized in that the negotiation step includes both setting up a signaling channel and also setting up a multiplex for the signaling channel and the audio and video logical channels.

6. A method according to claim 1, characterized in that:
it conforms to the ITU H 324 protocol;
the call set-up request step is a SETUP step of that protocol;
the alert step is an ALERTING step of that protocol;
the connection step is a CONNECT step of that protocol; and
the negotiation step corresponds both to the ITU H 245 protocol for setting up a signaling channel and also to the ITU H 223 protocol for setting up a multiplex for the signaling channel and the audio and video logical channels.

7. A method according to claim 1, characterized in that on transfer from the called terminal to a call-forwarding terminal, a new step of negotiating the setting up of audio and video logical channels between the calling terminal and the call-forwarding terminal begins only after the beginning of the step of connecting the calling terminal and the call-forwarding terminal.

8. A calling terminal suitable:
for sending a call set-up request message (SETUP);
for receiving an alert message (ALERTING) indicating that a called terminal has been alerted;
for receiving a connection message (CONNECT) indicating that a user of a called terminal has taken the call; and
for negotiating with a called terminal both the setting up of a signaling channel and also the setting up of a multiplex for the signaling channel and the audio and video logical channels,
which calling terminal is characterized in that it includes means for starting negotiation after receiving the alert message but before receiving the connection message.

9. A called terminal suitable:
for receiving a call set-up request message (SETUP);
for sending an alert message (ALERTING) indicating that said called terminal has been alerted;
for sending a connection message (CONNECT) indicating that a user of said called terminal has taken the call; and
for negotiating with the calling terminal both the setting up of a signaling channel and also the setting up of a multiplex for the signaling channel and the audio and video logical channels,
which called terminal is characterized in that it includes means for starting negotiation after sending the alert message but before sending the connection message.
